(19) United States
(12) Patent Application Publication
(10) Pub. No.: US 2024/0361538 A1
(43) Pub. Date: Oct. 31, 2024

(54) PHOTONIC INTEGRATED CIRCUIT PACKAGE WITH ALIGNMENT FEATURES

(71) Applicant: 3M INNOVATIVE PROPERTIES COMPANY, Saint Paul, MN (US)

(72) Inventors: Michael A. Haase, St. Paul, MN (US); Nicholas A. Lee, Woodbury, MN (US)

(21) Appl. No.: 18/558,418

(22) PCT Filed: Apr. 21, 2022
(86) PCT No.: PCT/IB2022/053748

§ 371 Date: Nov. 1, 2023

Related U.S. Application Data
(60) Provisional application No. 63/183,287, filed on May 3, 2021.

(51) Int. Cl. G02B 6/38

(52) U.S. Cl. CPC G02B 6/3873; G02B 6/3829

(57) ABSTRACT

An opto-electronic assembly includes a substrate having a plurality of first optical waveguides, a cradle, and a first cover encapsulating at least portions of the first optical waveguides and the cradle. The cradle is bonded to the substrate and defines a pocket therein having an opening. The pocket is configured to receive an optical ferrule through the opening and align the optical ferrule to the first optical waveguides. The first cover includes an aperture exposing the opening of the pocket, such that when the optical ferrule is received in the pocket through the opening and secured therein and a plurality of second optical waveguides are attached to the optical ferrule, the opto-electronic assembly is configured to transfer light between the pluralities of first and second optical waveguides.

### SUMMARY

In some aspects of the present description, an opto-electronic assembly is provided, the opto-electronic assembly including a substrate having a plurality of first optical waveguides, a cradle, and a first cover encapsulating at least portions of the first optical waveguides and the cradle. The cradle is bonded to the substrate and defines a pocket therein. The pocket has an opening and is configured to receive an optical ferrule through the opening and align the optical ferrule to the first optical waveguides. The first cover includes an aperture exposing the opening of the pocket, such that when the optical ferrule is received in the pocket through the opening and secured therein and a plurality of second optical waveguides are attached to the optical ferrule, the opto-electronic assembly is configured to transfer light between the pluralities of first and second optical waveguides.

In some aspects of the present description, an opto-electronic assembly is provided, the opto-electric assembly including a substrate having an electrically conductive trace, a cradle bonded to the substrate and defining a pocket therein, and an overmold covering at least portions of the substrate and the cradle. The overmold defines an opening therein at least partially exposing the pocket for receiving an optical ferrule therein so that light may be transferred between an optical element and an optical waveguide attached to the optical ferrule. The optical element is at least partially encapsulated by the overmold.

In some aspects of the present description, a method of making an optical connection between an optical ferrule and an optical component is provide. The optical component has a substrate with a plurality of first optical waveguides. The method includes the steps of aligning an optical cradle to the plurality of first optical waveguides, the optical cradle including a pocket for receiving an optical ferrule, and the pocket having an opening, encapsulating at least portions of the first optical waveguides and the cradle, but not the opening, with a first cover, and inserting the optical ferrule in the pocket through the opening.

### BRIEF DESCRIPTION OF THE DRAWINGS

FIG. 1 is a perspective, exploded view of an opto-electronic assembly, in accordance with an embodiment of the present description:

FIG. 2 is a perspective, assembled view of an opto-electronic assembly, in accordance with an embodiment of the present description:

FIG. 3 is a perspective, cutaway view of an opto-electronic assembly, showing internal details of the assembly, in accordance with an embodiment of the present description:

FIG. 4 is a perspective, cutaway view of an opto-electronic assembly, showing an alternate view of the assembly and a light path therethrough, in accordance with an embodiment of the present description:

FIGS. 5A-5C show alternate, cutaway views of an opto-electronic assembly, in accordance with an embodiment of the present description:

FIGS. 6A-6B show perspective views of the lead frame and cradle of an opto-electronic assembly, in accordance with an embodiment of the present description:

FIG. 7 is a perspective view of an opto-electronic assembly with an alternate cradle configuration, in accordance with an embodiment of the present description; and

FIG. 8 is a flowchart showing the steps in a method for making an optical connection between an optical ferrule and an optical component on a substrate, in accordance with an embodiment of the present description.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

As data rates in computers continue to rise, copper conductors become increasingly unable to transport the highspeed data between components at the speeds the customers demand. The use of silicon photonics helps ease this bottleneck by enabling data transport through optical fiber rather than copper traces. One challenge in providing fiber optic connectivity to silicon photonics packages is getting the light into and out of the protective packaging surrounding the integrated circuit chips. Having the ability to align optical cables accurately and efficiently on the outside of a package to the silicon photonics waveguides on the inside of a package would provide a rugged method to support high data rates and enhance hyper-scale datacenter performance.

According to some aspects of the present description, an opto-electronic assembly includes a substrate having a plurality of first optical waveguides, a cradle, and a first cover encapsulating at least portions of the first optical waveguides and the cradle. In some embodiments, the cradle may be bonded to the substrate and may define a pocket therein. In some embodiments, the pocket may have an opening and the pocket may be configured to receive an optical ferrule through the opening and align the optical ferrule to the first optical waveguides. In some embodiments, the opening is an open top of the pocket (i.e., the side of the cradle opposite the side of the cradle which is bonded to the substrate, such that the optical ferrule is lowered into the pocket in a direction substantially orthogonal to the plane of the substrate). In other embodiments, the opening is an open side of the pocket (i.e., a side of the cradle adjacent the side of the cradle which is bonded to the substrate, such that the optical ferrule slides into the pocket in a direction substantially parallel to the plane of the substrate). In some embodiments, the pocket of the cradle may include at least one mechanical alignment feature configured to align the optical ferrule to at least one of the plurality of first optical waveguides.

In some embodiments, the first cover may include an aperture exposing the opening of the pocket. In some embodiments, when the optical ferrule is received in the pocket through the opening and secured therein, and a plurality of second optical waveguides (e.g., optical fibers) is attached to the optical ferrule, the opto-electronic assembly may be configured to transfer light between the pluralities of first and second optical waveguides. In some embodiments, the first cover may provide a seal for the at least portions of the first optical waveguides and the cradle, except for the opening therein. In some embodiments, the opto-electronic assembly may further include an adhesive, where the adhesive at least partially fills a space between the first cover and the substrate. In some embodiments, the first cover may be an overmold.

In some embodiments, the opto-electronic assembly may further include an outer cap. In some embodiments, the outer cap may cover the opening and secure the optical ferrule in the pocket (e.g., prevent the optical ferrule from being removed or falling out). In some embodiments, the outer cap may provide strain relief to at least some of the plurality of second optical waveguides (e.g., may provide support to the optical waveguides where they emerge from the optical ferrule, and/or retain the optical waveguides in place). In some embodiments, the opto-electronic assembly may further include an adhesive securing the outer cap to the opto-electric assembly.

In some embodiments, the cradle of the opto-electronic assembly may include integral optical lenses disposed between the plurality of first optical waveguides and the plurality of second optical waveguides, in the optical path between the two sets of waveguides. In some embodiments, the light transferred between the plurality of first optical waveguides and the plurality of second optical waveguides is substantially collimated for at least a portion of the optical path (e.g., in a gap between the optical ferrule and the cradle). In some embodiments, the substantially collimated light and the integral optical lenses enable an expanded beam optical connection between the plurality of first optical waveguides and the plurality of second optical waveguides.

According to some aspects of the present description, an opto-electric assembly includes a substrate having an electrically conductive trace, a cradle bonded to the substrate and defining a pocket therein, and an overmold covering at least portions of the substrate and the cradle. In some embodiments, the overmold defines an opening therein that may at least partially expose the pocket for receiving an optical ferrule therein so that light may be transferred between an optical element disposed on the substrate (e.g., an optical waveguide on the substrate, or an optical transmitter or receiver connected to an optical waveguide on the substrate) and an optical waveguide (e.g., an optical fiber) attached to the optical ferrule. In some embodiments, the optical element is at least partially encapsulated by the overmold.

In some embodiments, the opening in the overmold is an open top of the pocket. In other embodiments, the opening is an open side of the pocket. In some embodiments, the pocket of the cradle includes at least one mechanical alignment feature configured to align the optical ferrule to the optical element disposed on the substrate.

In some embodiments, the overmold encapsulates at least portions of the electrically conductive trace. In some embodiments, the overmold encapsulates at least portions of the optical element. In some embodiments, the overmold provides a seal around the opening (e.g., a seal around the at least portions of the substrate and the cradle but leaving the opening accessible). In some embodiments, the optical ferrule may be removably received in the pocket when the overmold is in place (i.e., it may be placed in the pocket through the opening and removed, even when the overmold is in place). In some embodiments, the opto-electronic assembly may include a second cover. In some embodiments, the second cover may cover the opening and help secure the optical ferrule in the pocket of the cradle. In some embodiments, an adhesive may be applied to the second cover (e.g., to fill at least a portion of the space between the second cover and the optical ferrule or the overmold, and to help secure the optical ferrule in the pocket of the cradle.)

According to some aspects of the present description, a method of making an optical connection between an optical ferrule and an optical component, the optical component having a substrate with a plurality of first optical waveguides, includes the steps of aligning an optical cradle to the plurality of first optical waveguides, the optical cradle including a pocket for receiving an optical ferrule, and the pocket having an opening: encapsulating at least portions of the first optical waveguides and the cradle, but not the opening, with a first cover; and inserting the optical ferrule in the pocket through the opening. In some embodiments, the method steps described above may be carried out in the order specified.

In some embodiments, the first cover may be an overmold, and the method may further include the step of overmolding the at least portions of the first optical waveguides and the cradle, but not the opening. In other embodiments, the first cover may be a separate piece (e.g., an injection-molded cover), and the method may further include the step of filling at least some of the space between the first cover and the substrate with an adhesive. In some embodiments, the first cover may provide a seal for the at least portions of the first optical waveguides and the cradle, except for the opening therein (i.e., the first cover may provide a seal around, but not over, the opening). In some embodiments, the method may further include the step of covering the opening and securing the optical ferrule in the pocket with a second cover.

In some embodiments, the cradle of the opto-electronic assembly may include integral optical lenses disposed between the optical waveguide attached to the optical ferrule and the optical element, in the optical path between the optical waveguide and the optical element. In some embodiments, the light transferred between the optical waveguide attached to the optical ferrule and the optical element is substantially collimated for at least a portion of the optical path (e.g., in a gap between the optical waveguide and the optical element). In some embodiments, the substantially collimated light and the integral optical lenses enable an expanded beam optical connection between the optical waveguide attached to the optical ferrule and the optical element.

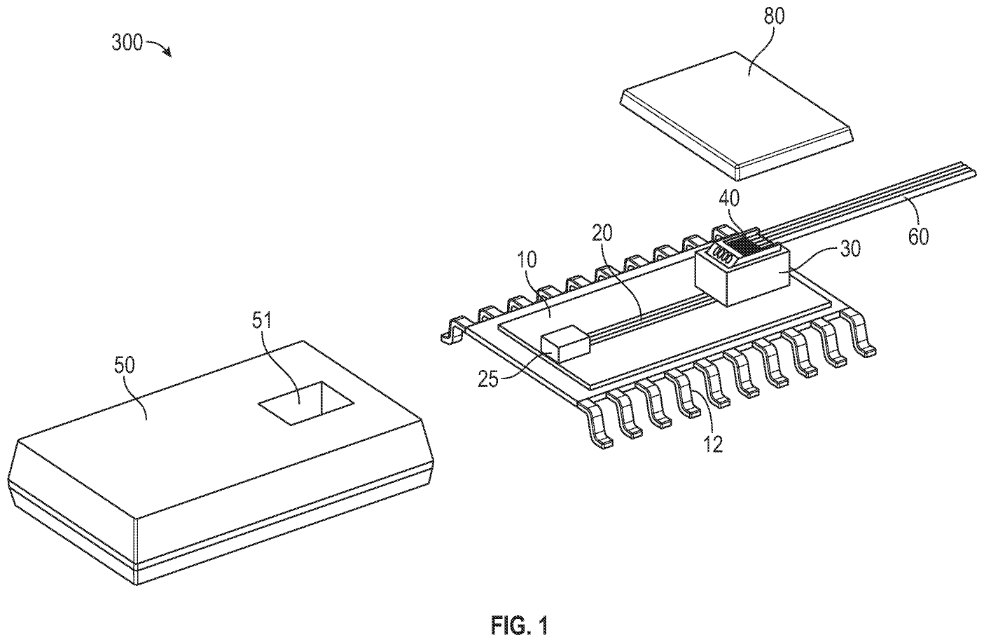

Turning now to the figures. FIG. 1 is a perspective, exploded view of an opto-electronic assembly 300 according to an embodiment described herein. In some embodiments, opto-electronic assembly 300 may include a substrate 10 attached to a mechanical lead frame 12, an optical cradle (or simply cradle) 30, and an optical ferrule (or simply ferrule) 40. In some embodiments, the cradle 30 may be bonded to substrate 10 and aligned to one or more optical waveguides 20 (e.g., a plurality of first optical waveguides 20) in substrate 10. In some embodiments, optical waveguides 20 may also be aligned optically with an optical element 25 (e.g., a photonics circuit, such as an optical transmitter or receiver, which in some embodiments may be attached to an optical waveguide 20 on the substrate 10).

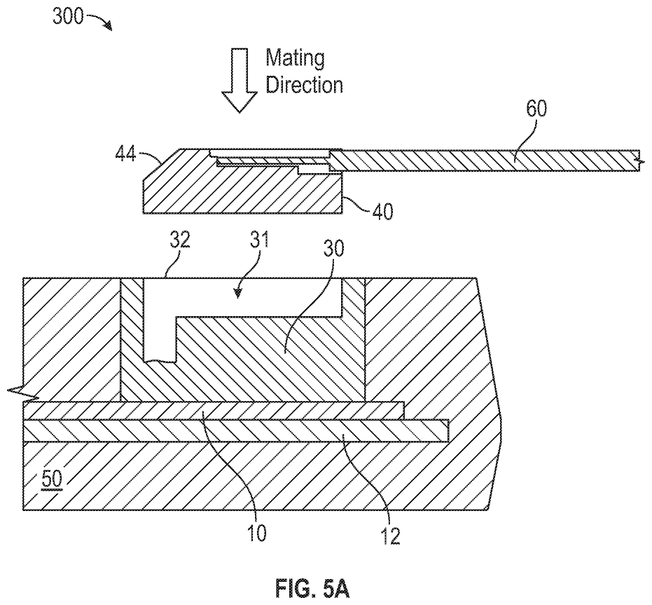

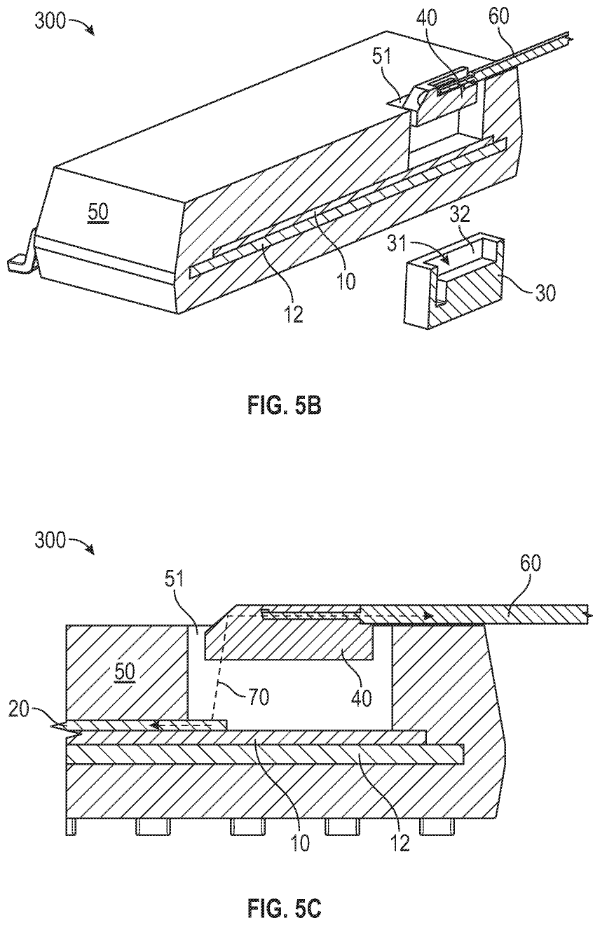

The cradle 30 may define a pocket 31 having an opening 32 (see, for example. FIG. 5A) and the cradle 30 may be configured to receive the ferrule 40 through opening 32 into pocket 31. In some embodiments, cradle 30 may have one or more mechanical alignment features disposed inside pocket 31 which are configured to align ferrule 40 to at least one of the optical waveguides 20. That is, when ferrule 40 is fully received within pocket 31 of cradle 30, ferrule 40 is in alignment to at least one of the optical waveguides 20, and this alignment may, in some embodiments, be aided by one or more mechanical alignment features inside pocket 31 of cradle 30. In this manner, proper alignment between optical ferrule 40 and the plurality of first optical waveguides 20 is ensured, while allowing ferrule 40 to be connected and removed easily.

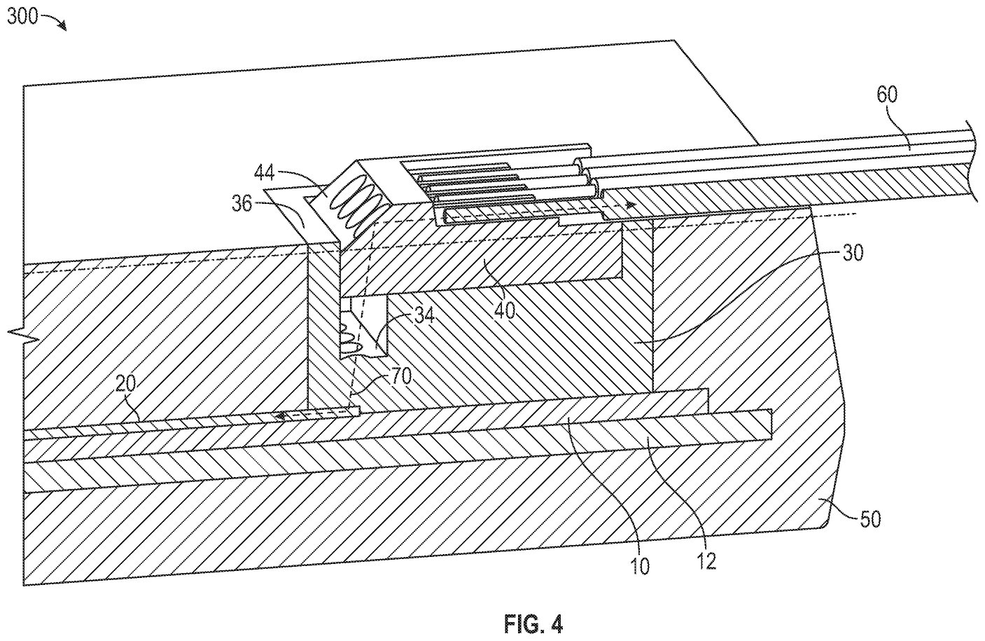

In some embodiments, a plurality of second optical waveguides 60 may be attached to optical ferrule 40, such that when optical ferrule 40 is seated in cradle 30, light may be transferred between the plurality of first optical waveguides 20 and the plurality of second optical waveguides 60. (An example of this transfer is shown in FIG. 4 and will be discussed elsewhere herein).

In some embodiments, a first cover 50 may encapsulate or otherwise cover at least portions of the plurality of first optical waveguides and the cradle. In some embodiments, optical element 25 may also be at least partially encapsulated by first cover 50. In some embodiments, first cover 50 may include an aperture 51 which, when first cover 50 is in place, leaves opening 32 of pocket 31 exposed. (Again, please see, for example. FIG. 5A, for details on opening 32 and pocket 31.) When first cover 50 is in place, optical ferrule 40 may be removably received (i.e., allowed to be inserted and removed) through aperture 51 and opening 32 in cradle 30. In some embodiments, a second cover 80 may be used to cover aperture 51 and to help retain optical ferrule 40 in its mated position within cradle 30. In some embodiments, second cover 80 may be adhered to first cover 50 with an adhesive or may snap into corresponding features (not shown) on first cover 50. In some embodiments, first cover 50 may be a separate component (e.g., a molded or tooled piece). In other embodiments, first cover 50 may be an overmold.

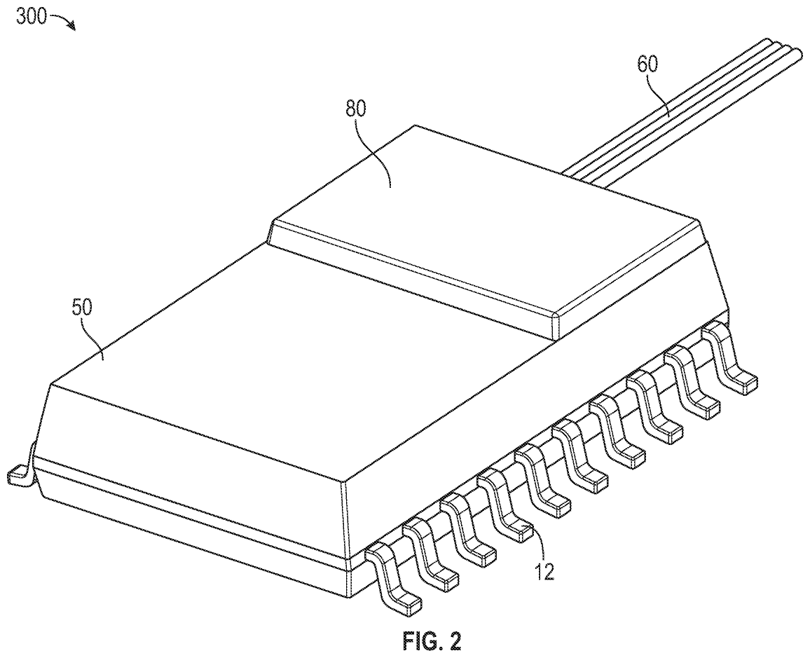

FIG. 2 is a perspective view of the opto-electronic assembly 300 of FIG. 1 in an assembled view. First cover 50 is in place, substantially covering substrate 10 and optical waveguides 20 (not shown in FIG. 2, see FIG. 1) with the appropriate portions of lead frame 12 (e.g., lead pins or other electrical connection features) emerging from first cover 50 as appropriate. In other embodiments, other mounting formats may be used, including, for example, surface-mount or ball grid arrays.

Second cover 80 is in place, covering the mated combination of optical ferrule and cradle, but allowing the plurality of second optical waveguides 60 to emerge from second cover 80 for appropriate connections to other devices or systems.

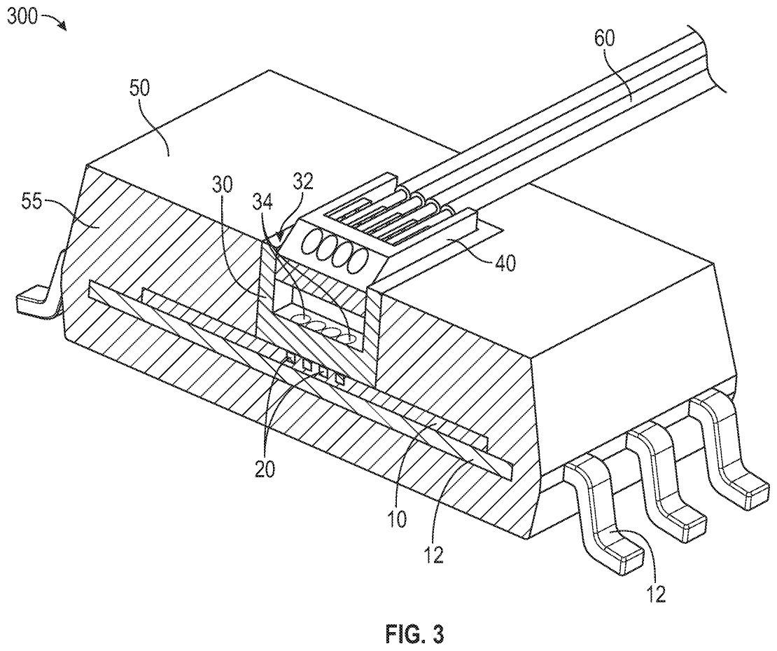

FIGS. 3 and 4 provide perspective, cutaway views of opto-electronic assembly 300 of FIG. 1, showing internal details of the assembly. The cutaway view of FIG. 3 shows assembly 300 cut across the assembly in a direction substantially orthogonal to the plurality of second optical waveguides 60, while FIG. 4 shows assembly 300 cut through the assembly in a direction substantially parallel to the plurality of second optical waveguides 60.

Looking first at FIG. 3, it can be seen that first cover 50 substantially encapsulates features of opto-electronic assembly 300, including substrate 10 (and optical waveguides 20), portions of lead frame 12, and portions of optical cradle 30, except for opening 32. FIG. 3 places the cut-line of the cutaway view such that the “front” face (the face that would be facing out of the page to the left of the figure, see feature 36 in FIG. 4) is removed, showing ferrule 40 seated inside cradle 30. In some embodiments, optical lenses 34 may be positioned inside cradle 30 such that they are in the light path between optical ferrule 40 and the plurality of first optical waveguides 20 in substrate 10. In some embodiments, such as when first cover 50 is an overmold, inner portion 55 may be at least partially filled with overmold material (i.e., at least partially filled as part of the overmold process so as to encapsulate features such as substrate 10). In other embodiments, when first cover 50 is a separate piece (not overmolded), or when there is a gap between the overmold and features such as substrate 10, inner portion 55 may be a material such as an adhesive which fills or partially fills any open spaces.

Turning now to FIG. 4, we see an alternate cutaway view with a cut line substantially orthogonal to the cut line of FIG. 3 (now showing “front” wall 36 of cradle 30, which was cutaway in FIG. 3). In the view of FIG. 4, light path 70 is shown between the plurality of first optical waveguides 20 on substrate 10 and the plurality of second optical waveguides 60 attached to ferrule 40. Light traveling light path 70 may, in some embodiments, move in both directions (i.e., light may travel bi-directionally). For example, light traveling through second optical waveguides 60 may enter optical ferrule 40, be redirected by (i.e., be reflected from) light redirecting surface 44, pass out an exit surface of optical ferrule 40, through integrated lens 34, and pass into first optical waveguides 20 on substrate 10. In some embodiments, the light may be substantially collimated for at least a portion of the optical path between the integrated lens 34 and redirecting surface 44, enabling an expanded-beam optical connection.

FIGS. 5A-5C show additional cutaway views of opto-electronic assembly 300 of the previous figures, providing additional details. FIG. 5A shows a side, cutaway view of assembly 300 in an unmated configuration to highlight details of cradle 30. For example, in some embodiments, cradle 30 includes pocket 31 with an opening 32 on a “top” side of cradle 30. Optical ferrule 40 is shown (with light redirecting surface 44 and plurality of second optical waveguides 60) above and removed from cradle 30, prior to mating.

In FIGS. 5B and 5C, optical cradle 30 is shown removed from opto-electronic assembly 300 for the purposes of clarity, showing details of first cover 50 and optical ferrule 40. For example, both FIGS. 5B and 5C provide views of aperture 51 in first cover 50. Details such as the arrangement of substrate 10, first optical waveguides 20, and lead frame 12 are shown in these figures. FIG. 5C provides another view of light path 70 as it passes from second optical waveguides 60, through optical ferrule 40 (where it is redirected), down into optical cradle 30 (which, as previously described, is omitted for clarity but would be disposed inside first cover 50), and into first optical waveguides 20 (as previously noted, optical path 70 may be bi-directional).

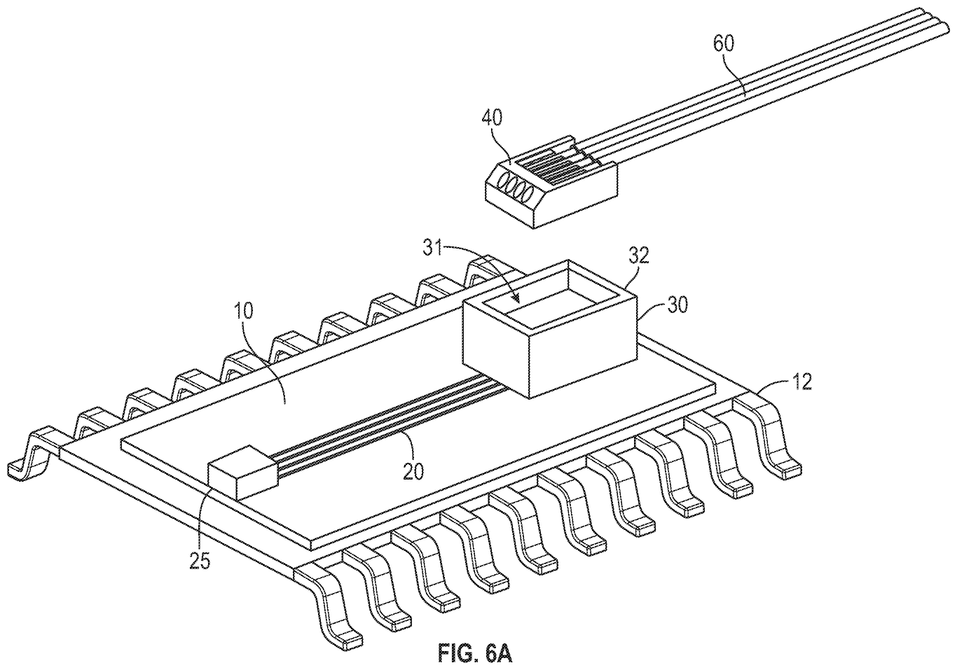

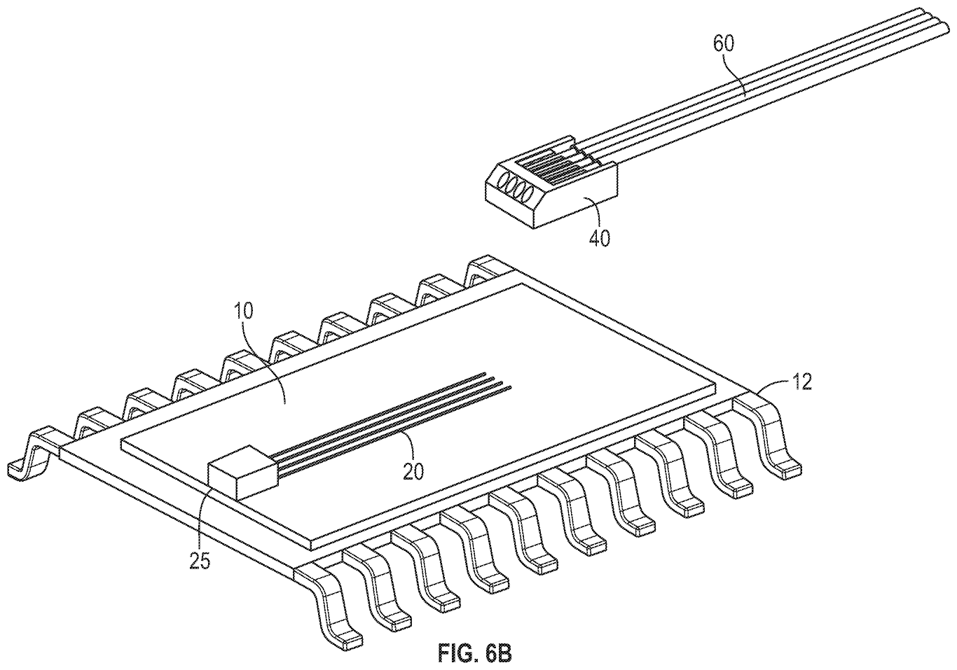

FIGS. 6A-6B show perspective views of the lead frame and cradle of an opto-electronic assembly, such as opto-electronic assembly 300 of FIG. 1. FIGS. 6A and 6B show optical ferrule 40 and its plurality of second optical waveguides 60 relative to plurality of first optical waveguides 20 embedded in or disposed on substrate 10. In both FIGS. 6A and 6B, first cover 50 (see, for example, first cover 50 of FIG. 1) has been omitted to show details of substrate 10 and lead frame 12. FIG. 6B also omits cradle 30 to allow first optical waveguides 20 to be more clearly viewed in relation to ferrule 40. FIGS. 6A and 6B are provided to show the physical relationship between first optical waveguides 20 (on substrate 10) and second optical waveguides 60 (attached to ferrule 40). That is, the bottom surface (surface facing the substrate) of optical ferrule 40 is intended to be aligned with an end of first optical waveguides 20. It is the bonding of optical cradle 30 to the end of first optical waveguides 20 (as well as the alignment provided by pocket 31 and its corresponding opening 32) that ensures optical alignment of the first optical waveguides 20 and second optical waveguides 60. Optical coupling of light into and out of waveguides 20 may be accomplished by any appropriate means, such as grating coupling, prism coupling, end coupling, or evanescent coupling. In some embodiments, optical waveguides 20 may also be aligned optically with an optical element 25 (e.g., a photonics circuit, such as an optical transmitter or receiver, which in some embodiments may be attached to an optical waveguide 20 on the substrate 10).

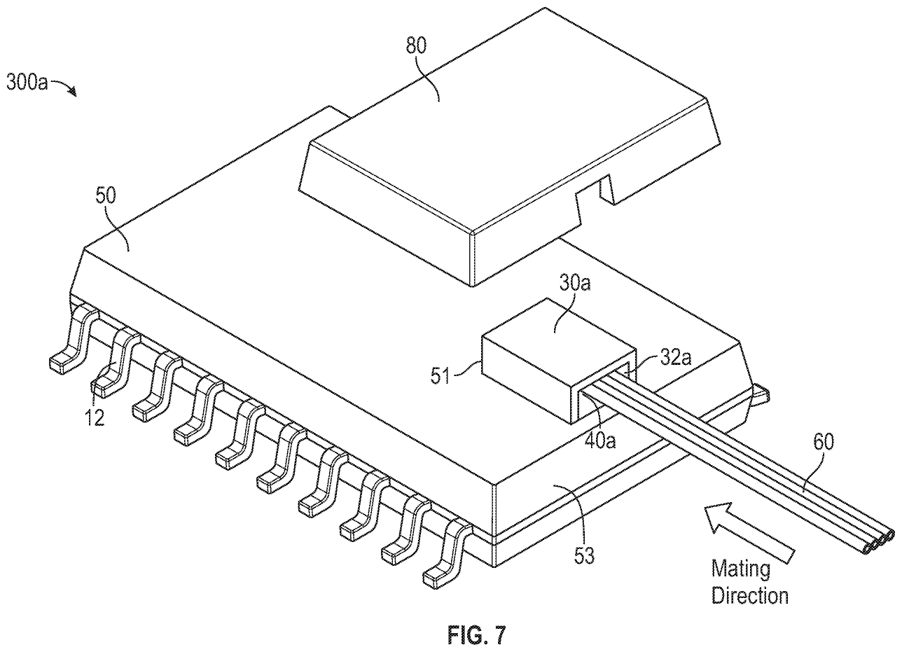

FIG. 7 provides a perspective view of an opto-electronic assembly 300a with an alternate cradle configuration. In other figures discussed elsewhere herein (for example, refer to FIG. 5B), optical cradle 30 is configured such that opening 32 is on a “top” side of cradle 30, such that the mating direction of optical ferrule 40 is down, toward the plane of substrate 10 (see, for example, the mating direction shown in FIG. 5A). By contrast, optical cradle 30a includes opening 32a on a side surface of cradle 30a, such that the mating direction of optical ferrule 40a is substantially parallel to the plane of substrate 10. In the embodiment of FIG. 7, first cover 50, aperture 51, and second cover 80 may be substantially identical to those of other embodiments described elsewhere herein. However, in some embodiments, optical cradle 30a may have an alternate configuration, including side opening 32a. Also, as the opening 32a is on a side of cradle 30a, a portion of optical cradle 30a may extend above the surface of first cover 50, as shown in FIG. 7, to allow opening 32a to be exposed outside first cover 50. In other embodiments, aperture 51 may be disposed on a side surface of first cover 50, such as side surface 53, to expose side opening 32a through first cover 50. In such embodiments, second cover 80 may need to be reconfigured to extend over side surface 53 to secure optical ferrule 40a in side opening 32a.

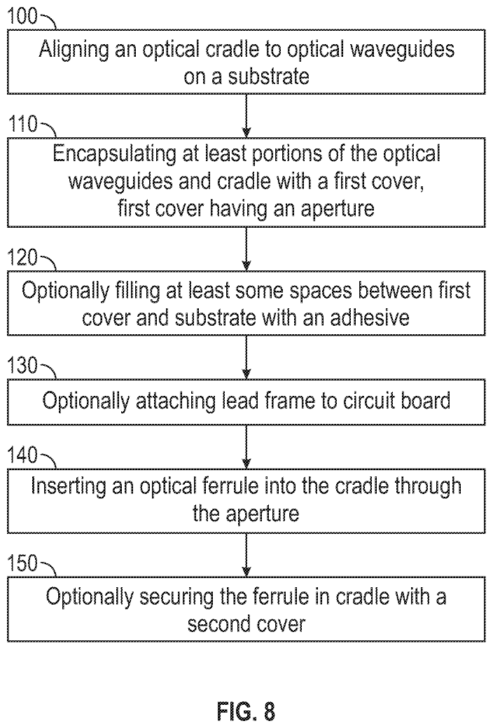

Finally. FIG. 8 is a flowchart showing the steps in a method for making an optical connection between an optical ferrule and an optical component on a substrate, according to an embodiment of the present description. In some embodiments, the steps described in FIG. 8 may be performed in the order specified. In Step 100, an optical cradle is aligned to the optical waveguides on a substrate. This may be done such that any optical components within the cradle (such as integral optical lenses, optical through-openings, etc.) are fixed in an aligned position relative to the optical waveguides. The cradle may be configured to receive a mating optical component, such as an optical ferrule, within an open pocket in the cradle. In some embodiments, the optical alignment may be done actively by inserting an optical ferrule into the optical cradle and aligning the cradle-ferrule assembly to maximize optical throughput from the ferrule waveguides to the substrate waveguides.

In Step 110, at least portions of the optical waveguides and at least portions of the optical cradle are encapsulated by a first cover, while the opening of the pocket of the cradle is left substantially uncovered (e.g., to allow a ferrule to be inserted during mating). In some embodiments, this first cover may be an overmold that covers the appropriate components after an overmolding process is performed. In Step 120, at least some of the open spaces or gaps between the first cover and the substrate may be filled with an adhesive or similar material. In some embodiments, a lead frame may be attached to the substrate in Step 130.

In Step 140, an optical ferrule is inserted into the open pocket of the optical cradle. In some embodiments, the optical cradle may have additional mechanical alignment features within the pocket to guide the ferrule into place and ensure it is properly aligned with the optical waveguides on the substrate.

In some embodiments, Step 150 may be performed, where a second cover is put in place over the mated optical ferrule, to help secure the optical ferrule within the pocket of the optical cradle and/or to provide an environmental seal. In some embodiments, this second cover may be bonded to the opto-electronic assembly with an adhesive or may be attached by mechanical latching features (e.g., snap features integral to the second cover, first cover, and/or the optical cradle).

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description. “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. An opto-electronic assembly comprising:
a substrate comprising a plurality of first optical waveguides;
a cradle bonded to the substrate and defining a pocket therein having an opening, the pocket configured to receive an optical ferrule through the opening and align the optical ferrule to the plurality of first optical waveguides; and
a first cover encapsulating at least portions of the plurality of first optical waveguides and the cradle, the first cover comprising an aperture exposing the opening of the pocket, such that when the optical ferrule is received in the pocket through the opening and secured therein and a plurality of second optical waveguides are attached to the optical ferrule, the opto-electronic assembly is configured to transfer light between the plurality of first optical waveguides and the plurality of second optical waveguides.

2. The opto-electronic assembly of claim 1, wherein the opening comprises an open top of the pocket.

3. The opto-electronic assembly of claim 1, wherein the opening comprises an open side of the pocket.

4. The opto-electronic assembly of claim 1, wherein the pocket of the cradle comprises at least one mechanical alignment feature configured to align the optical ferrule to at least one of the plurality of first optical waveguides.

5. The opto-electronic assembly of claim 1, wherein the first cover provides a seal for the at least portions of the plurality of first optical waveguides and the cradle, except for the opening therein.

6. The opto-electronic assembly of claim 1, further comprising an outer cap, the outer cap covering the opening and securing the optical ferrule in the pocket.

7. The opto-electronic assembly of claim 6, wherein the outer cap provides strain relief to at least some of the plurality of second optical waveguides.

8. The opto-electronic assembly of claim 6, further comprising an adhesive securing the outer cap to the opto-electronic assembly.

9. The opto-electronic assembly of claim 1, wherein the first cover is an overmold.

10. The opto-electronic assembly of claim 1, further comprising an adhesive, the adhesive at least partially filling a space between the first cover and the substrate.

11. The opto-electronic assembly of claim 1, wherein the cradle comprises integral optical lenses disposed between the plurality of first optical waveguides and the plurality of second optical waveguides.

12. The opto-electronic assembly of claim 11, wherein the light transferred between the plurality of first optical waveguides and the plurality of second optical waveguides is substantially collimated for at least a portion of the optical path between the plurality of first optical waveguides and the plurality of second optical waveguides.

13. The opto-electronic assembly of claim 12, further comprising an expanded beam optical connection between the plurality of first optical waveguides and the plurality of second optical waveguides.

14. An opto-electronic assembly comprising:
a substrate comprising an electrically conductive trace;
a cradle bonded to the substrate and defining a pocket therein; and
an overmold covering at least portions of the substrate and the cradle, the overmold defining an opening therein at least partially exposing the pocket for receiving an optical ferrule therein so that light may be transferred between an optical element disposed on the substrate and an optical waveguide attached to the optical ferrule, wherein the optical element is at least partially encapsulated by the overmold.

15. The opto-electronic assembly of claim 14, wherein the opening comprises an open top of the pocket.

16. The opto-electronic assembly of claim 14, wherein the opening comprises an open side of the pocket.

17. The opto-electronic assembly of claim 14, wherein the pocket of the cradle comprises at least one mechanical alignment feature configured to align the optical ferrule to the optical element.

18. The opto-electronic assembly of claim 14, wherein the overmold encapsulates at least portions of the electrically conductive trace.

19. The opto-electronic assembly of claim 14, wherein the optical ferrule is removably received in the pocket when the overmold is in place.

20. The opto-electronic assembly of claim 14, wherein the overmold provides a seal for the at least portions of the substrate and the cradle, except for the opening therein.

21-32. (canceled)
